(19) United States
(12) Patent Application Publication
(10) Pub. No.: US 2002/0118998 A1
(43) Pub. Date: Aug. 29, 2002

(54) Modular pipe node

(76) Inventor: Charles Boxenbaum, Brooklyn, NY (US)

Correspondence Address: Joseph Sofer, SOFER & HAROUN, L.L.P., Suite 1921, 342 Madison Avenue, New York, NY, 10173, US

(21) Appl. No.: 09/792,406

(22) Filed: Feb. 23, 2001

(51) Int. Cl. F16D 1/12

(52) U.S. Cl. 403/141

(57) ABSTRACT

A modular pipe node structure for joining pipe members is provided having first, second, third, and fourth complementary quadrant units. Each of the complementary quadrant units have first and second joining surfaces. Thus, when the second joining surface of the first unit is coupled to the first joining surface of the second unit, the second joining surface of the second unit is coupled to the first joining surface of the third unit, the second joining surface of the third unit is coupled to first surface of the fourth unit and the second joining surface of the fourth unit coupled to the first joining surface of the first unit, the joined together first, second, third and fourth units form a generally spherical structure having a first through-bore located on an x-axis of the sphere, a second through-bore located on a second y axis of the sphere, and a third through-bore located on a third z-axis of the sphere. Each of the through-bores are configured to receive individual pipe members.

### FIELD OF THE INVENTION

This invention relates to a node structure, and more particularly to a node structure for joining pipes to form constructions.

### BACKGROUND OF THE INVENTION

Pipe structures are widely used to build demountable and/or permanent structures such as shelters, railings, shelving, and displays. Such frames are considered advantageous as compared to other construction techniques for many reasons. For instance, pipe structures provide excellent loading characteristics, and they are relatively durable. Additionally, pipe structures provide cost advantages in comparison to other construction systems, and, among many other advantages, pipe structures are considered by many to be aesthetically pleasing. Pipe structures are employed in very large construction projects, such as for domes of sports stadiums. Even so, pipe structures can also be useful in much smaller projects, such as for shelving systems. Also, when properly sized, pipe structures can be used as construction toys.

Conventional pipe structures are three-dimensional assemblies formed with nodes that interconnect linear members. While any conceivable material can be used in pipe structure construction, nodes and members are typically formed from materials that have relatively high strength-to-weight ratios. Thus, materials such as polyvinyl chloride (PVC) and aluminum are frequently selected for this purpose. The linear members are often in the form of hollow tubes or pipes, further enhancing the strength-to-weight ratio of the ultimate structure.

There are many prior art examples that teach various node and member designs. Generally, the references are concerned with the nodes in particular, because, as alluded to above, the linear members can simply be lengths of standard piping. Node design primarily falls into two categories. The first is where the node has openings to receive members which are secured therein. Alternatively, another popular proposal is a node that has projections formed on the outer surface. Projections can be received by an appropriate hollow tube member and the member can be secured thereto.

In the first category, U.S. Pat. No. 3,921,360 to Baldwin discloses a structural framework and connector therefor. This reference discloses a connector having a shape defining an irregular polyhedron having twelve surfaces. The surfaces have openings configured to couple with elongated struts to provide a structurally stable framework or lattice type support structure. The connector in this reference is not modular in design. As such, difficulties may arise during the construction of a pipe structure. For instance, partial disassembly of a pipe structure may be required in order to add struts to the structure. Also, this system requires that the pipes are threaded before they can be used in the pipe structure.

U.S. Pat. No. 3,881,830 to Kato et al. teaches a combination pipe joint structure for constructing pipe structures. The joint units (nodes) have a plurality of feet projecting therefrom to receive pipe lengths. In order to fix a pipe length to a joint unit, a hole is bored through both the pipe and foot so that a bolt and nut can hold the components together. Alternatively, leaf springs can be used in the space between the feet and interior of the pipe. This node design is limited in its strength capabilities. Also, as with the previously discussed reference, this node is not modular in design.

### OBJECTS AND SUMMARY OF THE INVENTION

It is thus a general object of the present invention to provide a modular node structure for joining pipes to form orthogonal, co-planar pipe constructions.

A more specific object of the present invention is to provide a node structure that is relatively simple and cost-effective to manufacture.

It is another object of the present invention to provide a node structure that may be used with standard pipes without special treatment, e.g., priming, flaring, and tapping.

It is another object of the invention to provide a node structure that allows for relatively effortless construction of pipe structures.

It is yet another object of the invention to provide a node structure that consists of four individual quadrant units of the same design that combine to form the node structure suitable for joining two to six pipes.

Thus, according to one embodiment of the invention, a modular pipe node structure for joining pipe members is provided having first, second, third, and fourth complementary quadrant units. Each of the complementary quadrant units have first and second joining surfaces. Thus, when the second joining surface of the first unit is coupled to the first joining surface of the second unit, the second joining surface of the second unit is coupled to the first joining surface of the third unit, the second joining surface of the third unit is coupled to first surface of the fourth unit and the second joining surface of the fourth unit coupled to the first joining surface of the first unit, the joined together first, second, third and fourth units form a generally spherical structure having a first through-bore located on an x-axis of the sphere, a second through-bore located on a second y-axis of the sphere, and a third through-bore located on a third z-axis of the sphere. Each of the through-bores are configured to receive individual pipe members.

The above description sets forth rather broadly the more important features of the present invention in order that the detailed description thereof that follows may be understood, and in order that the present contributions to the art may be better appreciated. Other objects and features of the present invention will become apparent from the following detailed description considered in conjunction with the accompanying drawings. It is to be understood, however, that the drawings are designed solely for the purposes of illustration and not as a definition of the limits of the invention, for which reference should be made to the appended claims.

### BRIEF DESCRIPTION OF THE DRAWINGS

In the drawings in which like reference characters denote similar elements throughout the several views:

FIG. 1 is a perspective view of four quadrant units used to form a modular pipe node structure according to one embodiment of the invention;

FIG. 2a is a perspective view of one of the four quadrant units shown in FIG. 1, according to one embodiment of the invention;

FIG. 2b is a side view of one of the four quadrant units shown in FIG. 1, wherein the unit further includes a serrated cam washer;

FIG. 3 is a perspective view of the node shown in FIG. 1 where the quadrants have been joined to form a unitary unit holding pipe members, according to one embodiment of the invention;

FIG. 4 is a top view of the assembled modular pipe node structure as shown in FIG. 3, according to one embodiment of the invention;

FIG. 5 is a section view of the node taken along the line V-V in FIG. 4, according to one embodiment of the invention;

FIG. 6 is a perspective view of a pipe structure structure formed from a multitude of of modular pipe nodes such as the node shown in FIG. 5, according to one embodiment of the invention; and

FIG. 7 is a perspective view of a pipe structure structure formed from a multitude of modular pipe nodes such as the node shown in FIG. 5, the frame having been secured to a wall, according to one embodiment of the invention.

### DETAILED DESCRIPTION OF THE INVENTION

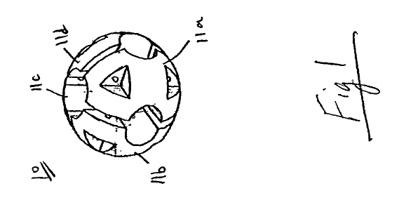

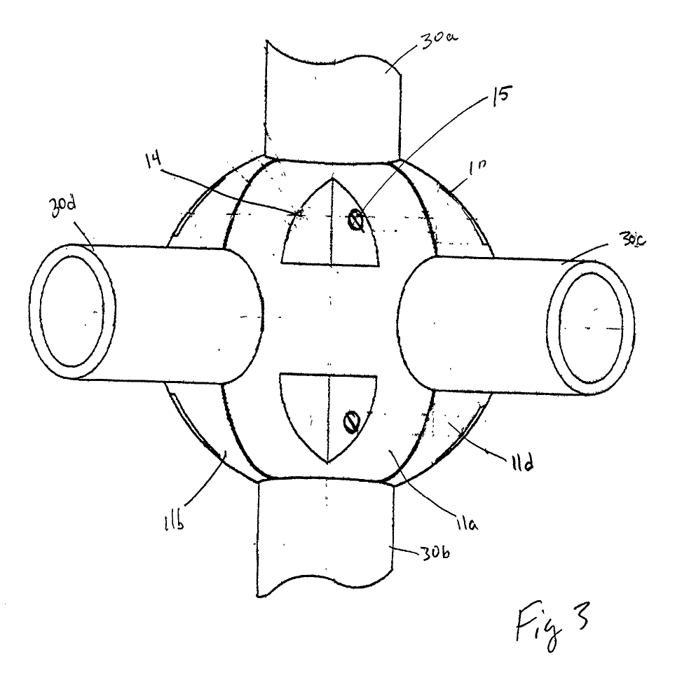

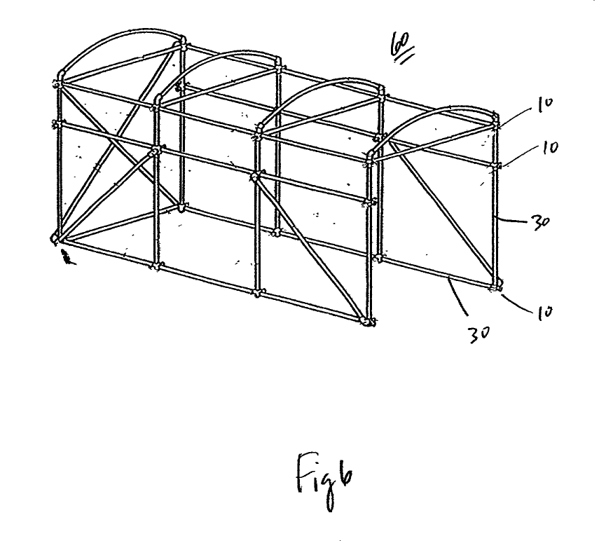

The present invention, in accordance with one embodiment, relates to a modular pipe node structure 10, illustrated in FIGS. 1-5, that can be used to construct pipe structures 60 such as the one shown in FIG. 6. As can be seen in FIG. 1, node 10 is made up of four complementary quadrant units 11a, 11b, 11c, and 11d, that attach to one another to form node 10 as shown in FIG. 3. As will be explained in more detail, the ability to separate quadrants 11a-d has many advantages over the prior art. All units 11a-d are identical to one another, each preferably representing a quarter of a sphere-shaped object. This simplifies manufacture, reduces material use, and eases assembly, among other advantages. However, it is understood that completed node may take on additional functional shapes such as a cube.

Preferably, node 10 is fabricated from aluminum. Aluminum is selected for its relatively high strength-to-weight characteristics and its satisfactory level of workability. However, there are many metals, plastics, and other materials that would be acceptable in this application. Units 11a-d may be machined or, in the alternative, units 11a-d may be cast in molds.

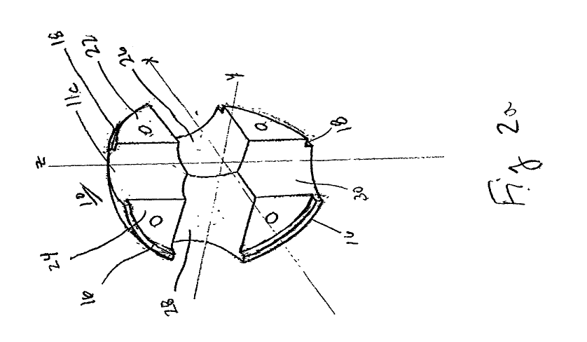

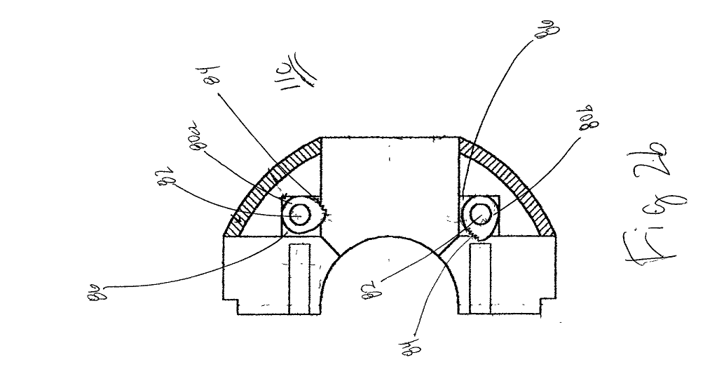

Now turning to FIG. 2a, unit 11c of node 10 is shown in more detail. As previously explained, unit 11c (and each other unit) is a quadrant from a sphere. As a consequence of this shape, a first joining surface 22 falls on a plane defined by the illustrated x-axis and z-axis. Likewise, a second joining surface 24 falls on a plane defined by the illustrated y-axis and z-axis. First joining surface 22 of unit 11c is configured to mate with a second joining surface (not shown) of unit 11d, and second joining surface 24 is configured to mate with a first joining surface (not shown) of unit 11b.

In the preferred embodiment, in order to provide for a more secure engagement, a overlap design is provided consisting of a lap receiver 18 disposed on first surface 22, and a lap extension 16 extending from second surface 24. Lap receiver 18 and lap extension 16 of unit 11c, respectively mate with lap extensions and lap receivers on other units. Specifically, this lap extension and lap receiver combination serves to counter shearing forces that may arise in a completed structure. Without the lap extension and lap receiver combination, these forces are instead borne on bolts 15 and pipes 30 (FIG. 3).

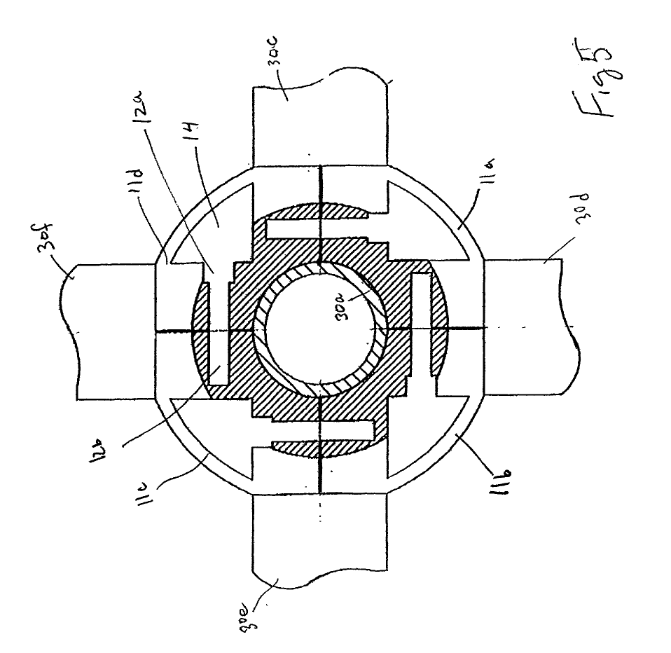

Still considering FIG. 2a, a first half-cylinder channel 26 is positioned on first surface 22 along the x-axis. Likewise, a second half-cylinder channel 28 is positioned on second surface 24 along the y-axis. Thus, for example, because all quadrant units are identical, when joined, first half-cylinder channel 26 and a second half-cylinder (not shown) of unit 11d form a through-bore capable of accommodating pipe 30f as shown in FIG. 5. A quarter-cylinder channel 30 is positioned along the z-axis on first surface 22 and second surface 24. Thus, in order to form a complete vertical through-bore, all four quadrants 11a-11d must be properly assembled so that each quarter-cylinder channel may complement the other. When node 10 is assembled, as shown in FIG. 1, through-bores form six openings that are in a mutually orthogonal relationship.

In accordance with one embodiment of the invention, the through-bores are eccentric. They are sized for the minimum allowable standard outside diameter of a given pipe size (e.g.- 1½″, 1¼″, etc.) in a fixed movable axis. The fixed movable axis is the one that is compressed upon assembly. The bores are also sized for the maximum allowable standard diameter in the fixed axis. This guarantees that the pipe whether over or undersized, within the acceptable industry- wide tolerance, will fit and be held tightly.

In one embodiment, all units of node 10, including unit 11c shown in FIG. 2b, include serrated cam washers 80 positioned in recesses 86. Cam washers 80 include through-holes 82 for receiving bolts 15 (FIG. 3). Preferably, through-h-holes 82 are tapped so as to capture bolts 15. This is desirable in that bolts 15 remain attached to unit 11c when node 10 is disassembled. This prevents bolts 15 from becoming misplaced. Cam washers 80 also include serrated surface 84 for gripping pipes 30. As such, a pipe 30 can freely enter a through-bore by forcing cam washer 80 to rotate into the position shown by washer 80b. When loads are applied on the finished structure, axial forces on a pipe 30 may cause it to be pulled from its through-bore. However, washers 80 help to prevent such movement. Specifically, serrated surfaces 84 of washers 80 frictionally engage pipe 30. As pipe 30 is pulled from the through-bore, washers 80 rotate into the position shown by washer 80a. Thus, the effective diameter of the through-bore is reduced as the pipe is pulled therefrom. In turn, pipe 30 is gripped with increasing force as the axial load on pipe 30 increases.

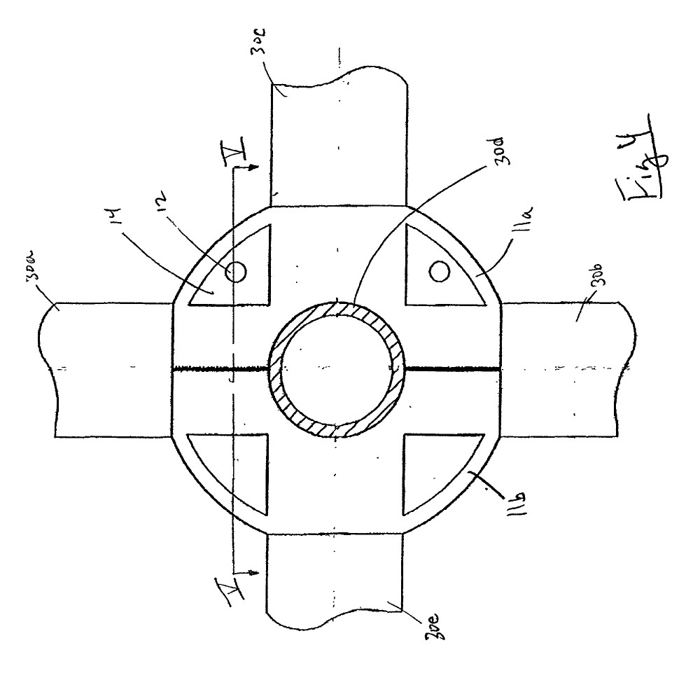

Now turning to FIG. 5, a sectional top view of node 10 taken from line V-V in FIG. 4 is shown. This view provides details with regard to bores 12a and 12b. For example, considering quadrant 11d, bore 12a runs from an exterior recess 14 of quadrant 11d though one of its joining surfaces. Exterior recess 14 is a preferred feature in that it provides a defined surface upon which bolt 15 may be tightened. A complementary bore 12b is disposed on first joining surface 22 of quadrant unit 11c. In this embodiment, bore 12b and possibly bore 12a are tapped so that an appropriate bolt can secure the two quadrants together. In another embodiment, bore 12b may continue through-h unit 12c so that a relatively larger bolt can be passed entirely through-h node 10 and secured by a pre-threaded nut. It is understood that quadrants 11a-d can be secured to one another by many other techniques. Thus, the above-described preferred techniques are not meant to limit the scope of the invention in any way.

In use, node 10 is assembled by loosely bolting four quadrant units 11a-d together. Tightening is avoided to allow pipes 30a-f to be inserted into horizontal and vertical through-bores formed by half and quarter cylinder channels. After insertion of pipes 30a-f, as shown in FIG. 3, bolts 15 may be tightened to secure pipes 30a-f, It is noted that the use of quadrant units makes it possible to remove one or pipes without disturbing the entire assembly. Another advantage of this modular design is that during construction, quadrants may be removed if necessary so that nodes can receive pipes even late in the construction process. Oftentimes, the use of conventional non-modular nodes may instead require in partial disassembly of a pipe structure, late in the construction process, in order to accommodate an additional pipe.

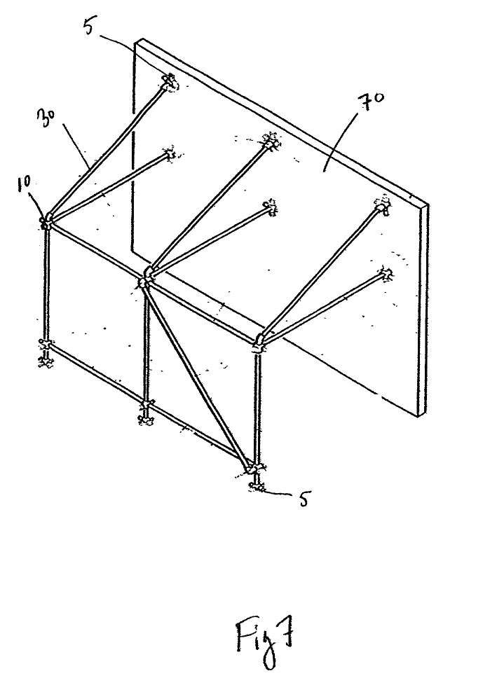

With reference to FIG. 7, in some cases it may be desirable to form a pipe structure in conjunction with an existing upright wall or panel 70. Pipe members 30 may be joined together using nodes 10 to form the desired frame. Half nodes 5, including only two of the four quadrants required to make up node 10, are then used to join the frame to wall 70. In the preferred embodiment, quadrant units used for this purpose have additional bores to aid in secure attachment to wall 70. Similarly, as is also shown, half nodes 5 may also be used as a base to support the frame structure.

It is understood that two or more nodes can be joined directly together so as to provide for additional angles for pipes to be mounted. This is useful considering that in the configuration described herein, each node provides through-bores that are all 90 degrees apart. Joining two nodes allows for cross members and the like to be built into a design.

Thus, while there have been shown and described and pointed out fundamental novel features of the invention as applied to alternative embodiments thereof, it will be understood that various omissions and substitutions and changes in the form and details of the disclosed invention may be made by those skilled in the art without departing from the spirit of the invention. It is the intention, therefore, to be limited only as indicated by the scope of the claims appended hereto. It is to be understood that the drawings are not necessarily drawn to scale, but that they are merely conceptual in nature.

What is claimed is:

1. A modular pipe mode structure for joining pipe members comprising:
first, second, third, and fourth complementary quadrant units, each of said first, second, third and fourth complementary quadrant units having first and second joining surfaces so that when the second joining surface of the first unit is coupled to said first joining surface of said second unit, said second joining surface of said second unit is coupled to said first joining surface of said third unit, said second joining surface of said third unit is coupled to first surface of said fourth unit and said second joining surface of said fourth unit coupled to said first joining surface of said first unit, said joined together first, second, third and fourth units form a structure having a first through-bore located on an x-axis of said structure, a second through-bore located on a second y-axis of said structure, and a third through-bore located on a third z-axis of said structure, each of said through-bores configured to receive individual pipe members.

2. A modular pipe node structure in accordance with claim 1, wherein said first joining surface of each of said units further comprises a lap receiver, and said second joining surface further comprises a lap extension that is configured to matingly engage said lap receiver of another unit.

3. A modular pipe node structure in accordance with claim 1, wherein said first joining surface further comprises at least one bore and said second joining surface further comprises at least one bore corresponding to said at least one bore of said first joining surface, so that when said first joining surface of one unit is joined to said second joining surface of another unit, said bores can receive at least one bolt for securing said units to one another.

4. A modular pipe node structure in accordance with claim 3, wherein each of said bores is configured to retain a serrated washer cam, said at least one bolt configured to be secured to said serrated washer cam, said serrated washer cam further configured to rotate about an access of said bolt so that a serrated portion of said serrated washer cam frictionally engages one of said pipe members, preventing removal of said pipe member from one of said through-bores.

5. A modular pipe node structure in accordance with claim 3, wherein said at least one bore on said first joining surface and said at least one bore on said second joining surface are recessed within said unit.

6. A modular pipe node structure in accordance with claim 3, wherein said bores are threaded.

7. A modular pipe node structure in accordance with claim 1, wherein said structure is fabricated from metal.

8. A modular pipe node structure in accordance with claim 1, wherein said structure is fabricated from plastic.

9. A modular pipe node structure in accordance with claim 1, wherein the diameters of said first, second, and third through-bores are sized for the minimum allowable standard outside diameter of said pipe members in a first axis that is compressed upon assembly, and are sized for maximum allowable standard diameter in a second axis.

10. A modular pipe node structure in accordance with claim 1, wherein said structure is generally spherical in geometry.
